(19) United States
(12) Patent Application Publication
(10) Pub. No.: US 2018/0085718 A1
(43) Pub. Date: Mar. 29, 2018

(54) Continuous Process for Dispersing Solid Material in a Liquid

(71) Applicant: Akzo Nobel Coatings International B.V., Amhem (NL)

(72) Inventors: Abele Broer Van Der Meer, Renkum (NL); Jozef Johannes Maria Baltussen, Nijmegen (NL)

(21) Appl. No.: 15/563,394

(22) PCT Filed: Apr. 8, 2016
(86) PCT No.: PCT/EP2016/057722

§ 371 Date: Sep. 29, 2017

(30) Foreign Application Priority Data
Apr. 9, 2015 (EP) 15162928.4

(51) Int. Cl. B01F 3/12; B01F 15/00

(52) U.S. Cl. CPC B01F 3/1221; B01F 3/1271; B01F 2215/005; B01F 15/00149; B01F 3/1207

(57) ABSTRACT

A continuous process for dispersing a particulate solid material in a liquid comprising the steps of a) dosing a particulate solid material feed stream via a particulate solid feed line (1) into a mixing chamber (2), b) simultaneously dosing a liquid feed stream via a liquid feed line (3) into the mixing chamber (2), wherein at least one of the feed streams additionally comprises an organic film-forming binder, c) simultaneously exerting a shear force on the content of the mixing chamber (2) sufficient to mix the particulate solid material and the liquid to form a mixture of particulate solid in the liquid, and d) simultaneously exerting a shear force to the mixture of particulate solid in the liquid sufficient to reduce the particle size of the particulate solid material in a dispersing chamber (4) to form a particulate solid material dispersed in the liquid, and e) simultaneously removing a liquid product stream of particulate solid material dispersed in the liquid from the dispersing chamber via a liquid dispersion outlet line (5), wherein the mixing chamber (2) and the dispersing chamber (4) are one single chamber (2, 4), wherein the particulate solid material is in the form of powder, granules or pellets.

The invention relates to a continuous process for dispersing a particulate solid material in a liquid. In particular embodiments, the resulting liquid product stream is paint or a paint precursor.

DE 196 29 945 A describes an apparatus for mixing powder- and/or granular particles with a liquid. The apparatus is equipped with a vertical central feed line for solid materials, at least one mixing tool pivoting around a vertical axis, and a lateral liquid feed line. Reduction of the particle size of the powder- or granular particles is not described.

US 2004/0190367 A is directed to an apparatus and methods for continuously producing paint with automatic adjustment of colour. The system includes a main mixing pipe connected to storage vessels to continuously receive flows of paint components from the storage vessels. The paint components are liquids.

Pigments, fillers or extenders present in paint are typically provided as solids by the suppliers, and the particle size of the solids has to be reduced, for example by wet grinding in order to obtain good hiding and coloring properties, as well as stability of the dispersed solids in the liquid paint. The grinding step is typically carried out as a discontinuous process. Alternatively, liquid pigment preparations containing pre-dispersed pigments can be used in paint production. However, the liquid pigment preparations are likewise prepared in batch processes.

There is a need for improved continuous processes suitable for the integrated production of paint or paint precursors from liquids and particulate solid starting materials. The process should also be flexible in the sense that it is easy to change between different recipes for different types of paint or various colors. The process should also be flexible regarding the amount of paint or paint precursor produced. The process should also consume less energy than conventional processes.

The invention now provides a continuous process for dispersing a particulate solid material in a liquid comprising the steps of
a) dosing a particulate solid material feed stream via a particulate solid feed line into a mixing chamber,
b) simultaneously dosing a liquid feed stream via a liquid feed line into the mixing chamber, wherein at least one of the feed streams comprises an organic film-forming binder,
c) simultaneously exerting shear force on the content of the mixing chamber sufficient to mix the particulate solid material and the liquid to form a mixture of particulate solid in the liquid, and
d) simultaneously exerting a shear force to the mixture of particulate solid in the liquid sufficient to reduce the particle size of the particulate solid material in a dispersing chamber to form a particulate solid material dispersed in the liquid, and
e) simultaneously removing a liquid product stream of particulate solid material dispersed in the liquid from the dispersing chamber via a liquid dispersion outlet line,

wherein the mixing chamber (2) and the dispersing chamber (4) are one single chamber (2,4),

wherein the particulate solid material is in the form of powder, granules or pellets.

In the process the particulate solid material is dosed into a mixing chamber. Dosing can be effected by generally known techniques for transporting and dosing solid materials. Suitable examples include screw conveyors, rotary valves, pistons, blowers, conveyor belts, and the like. The particulate solid material is suitably withdrawn from a solid material storage container. In one embodiment part of the particulate solid feed line is arranged downward so as to allow the particulate solid to be transported by gravity. Dosing is suitably controlled by some metering means, for example by metering the volume or the weight of the dosed particulate solid. In embodiments wherein the process is carried out under the control of a suitable programmed data processing unit, the volume or weight dosed per time unit can be controlled and monitored via suitable input and output means of the data processing unit.

The solid particulate material may be used in powder form or in granular form, for example in the form of a powder. In other embodiments, the solid material may also be in form of pellets, for example in order to prevent dusting. Powders may also have been treated with anti-dusting agents to reduce dust formation. Solid particulate material means here a solid material consisting of particles that are not separated by a liquid phase. Specifically, moist filter cakes are not considered solid particular material in the present description. It is advantageous to use solid particulate material in the form of powders, granules or pellets, because these are especially suitable for continuous operation. Powder is understood here to be dry particles dispersed in air. The powder is preferably free-flowing. It is also preferred that the solid particulate material contains less than 10 wt. % liquid, preferably less than 2 wt. %, more preferably less than 0.5 wt. %.

The particulate solid material typically comprises a material selected from pigments, fillers, extenders, and mixtures thereof. Pigments are generally used in paints to impart color and hiding power. An example of a widely used white pigment is TiO₂. Also BaSO₄ may be mentioned as an example of a white pigment/filler. The choice and amount of pigments depends, among others, on the desired color and hiding power. Filler materials and extenders may be used to obtain desired physical or chemical properties of the end product. Examples of suitable fillers and extenders include carbonates, sulfates, silicates and oxides of magnesium, calcium, and aluminum. Further examples of pigments include anti-corrosion pigments such as zinc phosphates and zinc silicates, zinc metaborate or barium metaborate monohydrate, nanodisperse oxides, and other anti-corrosion pigments familiar to the skilled person. In one embodiment, a mixture of at least two particulate solid materials is dosed via the particulate solid feed line, for example a mixture of two or more pigments, or a mixture of at least one pigment and at least one filler material. In this case, at least two solid materials are suitably pre-mixed in the desired ratio.

In an alternative embodiment, at least two different particulate solid materials are dosed via at least two particulate solid feed lines into the mixing chamber.

At least one of the feed streams additionally comprises an organic film-forming binder. Organic film-forming binders are generally known and used in paints. The organic film-forming binder typically is a polymeric or oligomeric resinous material capable of forming a film on a substrate. The film-forming binder may be of natural or synthetic origin. Examples of suitable film-forming binders are polyesters, polyolefins, polycarbonates, polyacrylates, polyurethanes, and mixtures and hybrids thereof. Also resins of natural origin or derivatives thereof may be present as film-forming binders. Rosin and rosin derivatives as well as cellulose based binders, such as cellulose acetate butyrate, may be mentioned as examples. The organic film-forming binder is typically present in dissolved or dispersed form in the liquid feed stream. However, suitable film-forming binders may also be present in the solid feed stream. This may, for example, be the case when the organic film-forming binder in itself is a solid particulate material, such as cellulose acetate butyrate.

The solid particulate material is dosed into a mixing chamber. The mixing chamber is the space wherein the particulate solid material, the liquid, and the organic film forming binder are combined, contacted, and mixed.

Simultaneously with the particulate solid material, a liquid is dosed into the mixing chamber. The liquid is suitably withdrawn from a liquid storage container. Dosing of the liquid can be effected by generally known techniques for transporting and dosing liquid materials. Suitable examples include various types of pumps, pistons, and the like. In one embodiment part of the liquid feed line may be arranged downward so as to allow the liquid to be transported by gravity. Dosing is suitably controlled by some metering means, for example by metering the volume or the weight of the dosed liquid. In embodiments wherein the process is carried out under the control of a suitable programmed data processing unit, the volume or weight of liquid dosed per time unit can be controlled and monitored via suitable input and output means of the data processing unit.

In one embodiment, the liquid is an aqueous liquid, comprising water as predominant volatile liquid. It should be noted, however, that the aqueous liquid may comprise minor or even substantial amounts of organic liquids, for example water-miscible organic solvents. When the liquid is an aqueous liquid, the film-forming binder may be dissolved in the aqueous liquid, for example in cases that the film-forming binder has sufficient hydrophilic or polar groups to render the binder soluble in water. Alternatively, the binder may be dispersed or emulsified in an aqueous liquid.

In a further embodiment, the liquid is a non-aqueous liquid. In this case, the liquid may comprise one or more organic solvents as they are typically used in paints. It should be noted, however, that the non-aqueous liquid may comprise minor or even substantial amounts of water, provided that the majority of the liquid phase consists of non-aqueous matter. Alternatively, use may also be made of film-forming binders which are liquid, or which are liquefied by mixing the binder with a so-called reactive diluent. In such cases, the use of volatile organic solvents can be minimized or eliminated.

In one embodiment, two or more different liquids are pre-mixed prior to being dosed via the liquid feed line to the mixing chamber. In a further embodiment, two or more liquid feed lines are present. All liquid feed lines may be used as liquid feed stream to the mixing chamber. Alternatively, one or more of the liquid feed lines may be used for feeding one or more liquids to the dispersing chamber.

In a separate embodiment, the process includes dosing of an at least second liquid through a second liquid feed line after the dispersing step, to the liquid dispersion outlet line (5). This has an advantage of being able to adjust the solids content of the dispersion. In some embodiments, e.g. relating to paint formulations, the dispersions obtained in the mixing dispersion device may have a too high solids content (e.g. up to 80 wt. %) and it is desired to add a liquid in order to obtain a product with a lower solids content (e.g. about 70%). This can be suitably done in an inline mixing device such as a mixing pump installed downstream of the mixing dispersion device.

In addition to the organic film-forming binder the liquid may optionally comprise other components and ingredients. Examples of such ingredients are those which are typically present in paints, such as additives to control the rheology, flow additives, dispersants, anti-foaming agents, curing catalysts, UV stabilizers, and the like.

In the mixing chamber a shear force is exerted on the content of the chamber sufficient to mix the particulate solid material and the liquid to form a mixture.

Mixing is typically carried out using at least one mixing tool which may have one or more mixing blades rotating around an axis in the mixing chamber. The shape and orientation of the blades and the axis can be varied significantly. Typically, the mixing tool is driven by an electric motor. In embodiments wherein the process is carried out under the control of a suitable programmed data processing unit, the electric power input and the rotation speed of the mixing tool can be controlled and monitored via suitable input and output means of the data processing unit. The mixing chamber may be shaped to optimize mixing efficiency, for example by the placement of internal flow directing vanes, panels or orifices. Shear force to obtain mixing may alternatively or additionally be exerted by other means, such as ultrasound or elongational flow. The result of the mixing step is a mixture of the particulate solid in the liquid. The resulting mixture is a liquid as well. The viscosity of the mixture can be such that the mixture is considered as a paste.

The duration and the shear force exerted during the mixing step can be varied so as to obtain the desired result. As the process is a continuous process, the amount of matter introduced into the mixing chamber per unit of time is identical to the amount of matter leaving the mixing chamber once the process has been started. Hence, there is a continuous flow of matter passing through the mixing chamber. As a consequence, the duration of the mixing step can be controlled by the flow speed through the mixing chamber.

The shear force exerted on the content of the mixing chamber can be controlled and varied by the shape, size and location of the mixing tool and the flow directing means. Furthermore, the (electrical) input power and rotating speed of the motor driving the mixing tool can be varied.

In the dispersing chamber, a shear force is exerted on the mixture of particulate solid in the liquid to reduce the particle size of the particulate solid material. Generally, compared to mixing only, a higher shear force or a longer residence time of the liquid in the chamber, or a combination of both is used in order to obtain the required reduction of particle size.

Dispersing is typically carried out using at least one dispersing tool which may have one or more dispersing blades rotating around an axis in the dispersing chamber. The shape and orientation of the blades and the axis can be varied significantly. Typically, the dispersing tool is driven by an electric motor. In embodiments wherein the process is carried out under the control of a suitable programmed data processing unit, the electric power input and the rotation speed of the dispersing tool can be controlled and monitored via suitable input and output means of the data processing unit. The dispersing chamber and tools may be shaped to optimize dispersing efficiency, for example by the placement of internal flow directing vanes, panels or orifices, or by optimizing the shape and geometry of the dispersing tools. In a preferred embodiment, the dispersing tool does not contain grinding elements, e.g. beads. Disadvantages of bead mill type devices include a low throughput, high energy consumption and difficulties in cleaning and switching to another product. Hence, these are less suitable for flexible, continuous dispersion production.

In some embodiments, the dispersing tool is a rotor-stator device. In a preferred embodiment the distance between the shear generating rotating tool and the non-rotating parts, such as a stator or the housing of the dispersing chamber, is smaller than 2 mm, preferably smaller than 1 mm and most preferably smaller than 0.55 mm.

It is also preferred that the dispersing chamber acts as a shear pump and that a positive pressure is generated over the inlet and the outlet of the dispersing chamber. This implies in this embodiment that due to the rotation of the rotating tools inside the dispersing chamber, the pressure at the outlet Pₒᵤₜ is higher than the pressure at the inlet of the dispersing chamber Pᵢₙ. Preferably Pₒᵤₜ-Pᵢₙ>0.1 bar, more preferably >0.5 bar and most preferably >1 bar. The pressure difference over the dispersing chamber is measured using water as a liquid and without the addition of powders. During the measurement the rotational speed is set at the maximum value and the flow is reduced by a valve between the maximum value and zero. The pressure is measured during this procedure and the maximum pressure difference is noted as Pₒᵤₜ-Pᵢₙ.

Shear force to obtain dispersing may alternatively or additionally be exerted by other means, such as ultrasound or elongational flow. The result of the dispersing step is a liquid dispersion of the particulate solid in the liquid, wherein the particle size is reduced, compared to the particulate solid material entering the process.

In one embodiment, reduction of the particle size is achieved by breaking up agglomerates of particles into primary particles or smaller agglomerates. This may be the main mechanism of particle size reduction for certain hard particles, in particular if the primary particles have a tendency to form agglomerates.

In addition to or as an alternative to breaking of agglomerates, the particle size may also be reduced by splitting primary particles present in the feed particulate solid into smaller particles.

During the dispersing step the particle surfaces of the particulate material are also wetted. Any air present on the surfaces is preferably displaced by liquid material. In some embodiments, dispersing agents present in the liquid phase may be enriched towards the particle surfaces. Wetting of the particle surfaces improves the stability of the dispersion and reduces processes of particle sedimentation or re-agglomeration. The duration and the level of the shear force exerted during the dispersing step can be varied so as to obtain the desired result. As the process is a continuous process, the amount of matter introduced into the dispersing chamber per unit of time is identical to the amount of matter leaving the mixing chamber. Hence, there is a continuous flow of matter passing through the dispersing chamber. As a consequence, the duration of the dispersing step can be controlled by the flow speed through the dispersing chamber, as well as by the size of the dispersing chamber.

The shear force exerted on the content of the dispersing chamber can be controlled and varied by the shape, size and location of the dispersing tool in the chamber, and the flow directing means. Furthermore, the (electrical) input power and rotating speed of the motor driving the dispersing tool can be varied. It is also possible to combine two or more dispersing tools in the dispersing chamber in order to obtain greater particle size reduction and improved wetting of the particulates in the dispersing step.

According to the present invention, the mixing chamber and the dispersing chamber are one single chamber. This is advantageous because no pre-mixing is necessary and because good quality dispersions are obtained in a one-step process starting from a particulate solid material feed and a liquid feed. This makes the process and process equipment simple and cost effective.

In the single chamber for mixing and dispersing, there may be a mixing zone and a dispersing zone, wherein the content of the chamber continuously moves from the mixing zone to the dispersing zone.

In a still further embodiment, the mixing and dispersing zone can be combined in the chamber. In this case, the particulate solid material particles are first mixed into the liquid, and subsequently dispersed to reduce the particle size by continued exertion of shear force. The mixing and dispersing tools are arranged as above.

During mixing and dispersing the mechanical energy introduced into the system is partially converted to thermal energy. Therefore, the temperature of the material passing through the mixing chamber and the dispersing chamber may increase during the process. Temperature sensors may be present at one or more locations to measure the temperature of the liquid stream passing through the process. In further embodiments, cooling means may be present to avoid excessive temperature increase of the liquid stream, or to maintain the temperature of the liquid product stream in a predetermined range.

The mixing dispersion device preferably has a low internal volume Vᵢ [liter] relative to the volumetric flow rate Φ [liter/second] through the device. The ratio of the internal volume Vᵢ to the volumetric flow rate Φ defines the residence time τ of the material in the mixing dispersion device by τ=Vᵢ/Φ. The small internal volume minimizes the need for cleaning and enhances the flexibility of the installation for switching between products. In some embodiments, the residence time τ is less than 60 seconds, preferably less than 30 seconds and most preferably less than 15 seconds. In case there are separate mixing and high shear zones in the device, it is preferred that the residence time in the high shear zone is less than 10 seconds, more preferably less than 5 seconds and most preferably less than 2 seconds. In the dispersing step the particle size of the particulate solid material is generally reduced to values which are appropriate for the intended purpose. For paints which are to be used as top coats and colour coats the particle size range is typically from 5 to 15 μm. For paints to be used as primers and fillers the particle size range may be 15 to 100 μm.

The particle size may be determined using a Hegman gauge, sometimes referred to as a grind gauge or grindometer. This is a device used to determine how finely the particles of pigment (or other solid) dispersed in a sample of paint (or other liquid) are ground. The gauge consists of a steel block with a series of very small parallel grooves machined into it. The grooves decrease in depth from one end of the block to the other, according to a scale stamped next to them. A typical Hegman gauge is 170 mm by 65 mm by 15 mm, with a channel of grooves running lengthwise, 12.5 mm across and narrowing uniformly in depth from 100 μm to zero.

A Hegman gauge is used by puddling a sample of paint at the deep end of the gauge and drawing the paint down with a flat edge along the grooves. The paint fills the grooves, and the location where a regular, significant “pepperyness” in the appearance of the coating appears, marks the coarsest-ground dispersed particles. The reading is taken from the scale marked next to the grooves, in dimensionless “Hegman units” and/or mils or micrometres. Other well-known methods of particle size determination may be used as well, for example laser diffraction methods.

A liquid product stream of particulate solid material dispersed in the liquid comprising the film forming binder is continuously removed from the dispersing chamber via a liquid dispersion outlet line. The liquid product stream may be collected in a product reservoir, or it may be pumped or otherwise conveyed to a collection tank.

In a further embodiment, liquid product stream quality parameters, for example particle size, viscosity, non-volatile content, or temperature are automatically determined and compared to target values. If the quality parameters are outside a target range, or moving towards the border of a target range, process parameters may be automatically adjusted to ensure that the quality parameters remain inside the target range. For example, if the particle size of the liquid product stream is too large, the flow rate through the apparatus may be reduced, or the electrical input power of the dispersing tool may be increased so as to ensure that the particle size remains in the target range.

The process is very suitable for fast, integrated production of paint or paint precursors from liquids and particulate solid starting materials. The small internal volume and surface of the equipment minimizes cleaning and rinsing needs when changing between different types of products. The simple continuous process can be carried out with variable run lengths and thus allows production of variable amounts of products. This improves supply chain efficiency and flexibility. The continuous, compact, fast and flexible production system leads to reduced costs for equipment, building, operation and maintenance. As closed equipment is used in the continuous process, the process reduces emissions of dust and volatile organic components and thus leads to an improvement of health and safety conditions. The continuous process, in combination with automated and accurate dosing equipment guarantees high quality standards and reduces the need for product adjustments after production. Another important advantage of the process of the invention is reduced energy consumption without compromising on the quality of the produced dispersion. Known single pass inline dispersion processes are energy intensive. The process described in EP1978062 requires more than 1800 kJ/kg, the process described in U.S. Pat. No. 3,957,210 consumes over 300 kJ/kg of energy. The process of the present invention is able to produce a high quality dispersion with an energy consumption below 300 kJ/kg, preferably lower than 200 kJ/kg and most preferably lower than 150 kJ/kg.

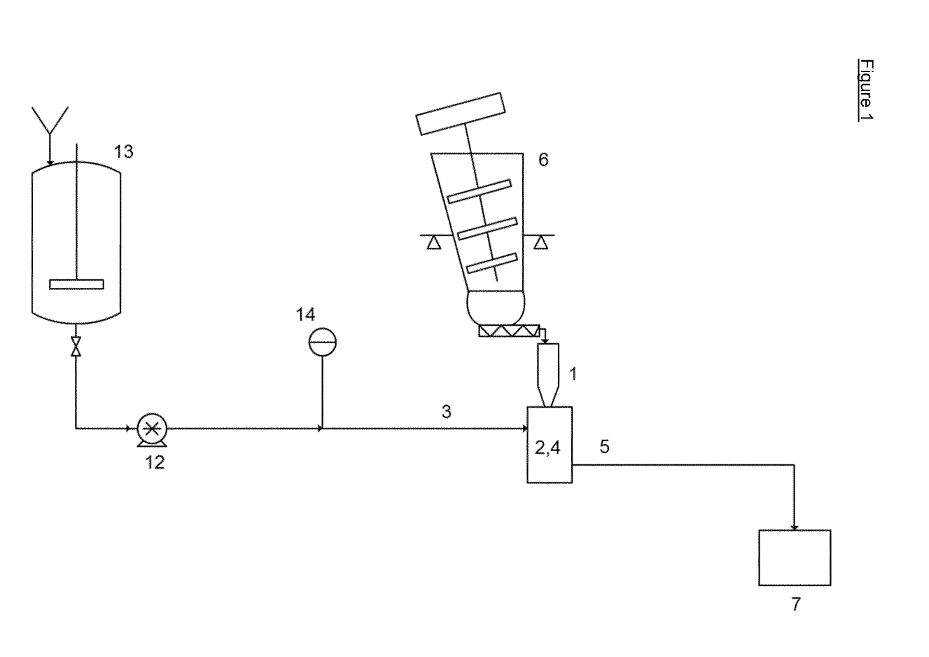

FIG. 1 illustrates an embodiment of the process. In this embodiment, a liquid tank (13) contains a liquid comprising an organic film forming binder. The liquid tank (13) is connected to the mixing and dispersing chamber (2,4) via a liquid feed line (3). The liquid feed stream is pumped via dosing pump (12) through the liquid feed line (3). The liquid feed line further comprises a flow meter (14) to monitor the amount of liquid feed stream dosed to the mixing and dispersing chamber (2,4). A powder dosing unit (6) is connected to the mixing and dispersing chamber (2,4) via the particulate solid feed line (1) for dosing the particulate solid material. In the mixing and dispersing chamber (2,4) a shear force is exerted on the content of the chamber to mix the particulate solid material and the liquid, and to reduce the particle size of the particulate solid material. The liquid product stream of particulate solid material dispersed in the liquid is removed from the mixing and dispersing chamber (2,4) via the liquid dispersion outlet line (5) and collected in a product container (7).

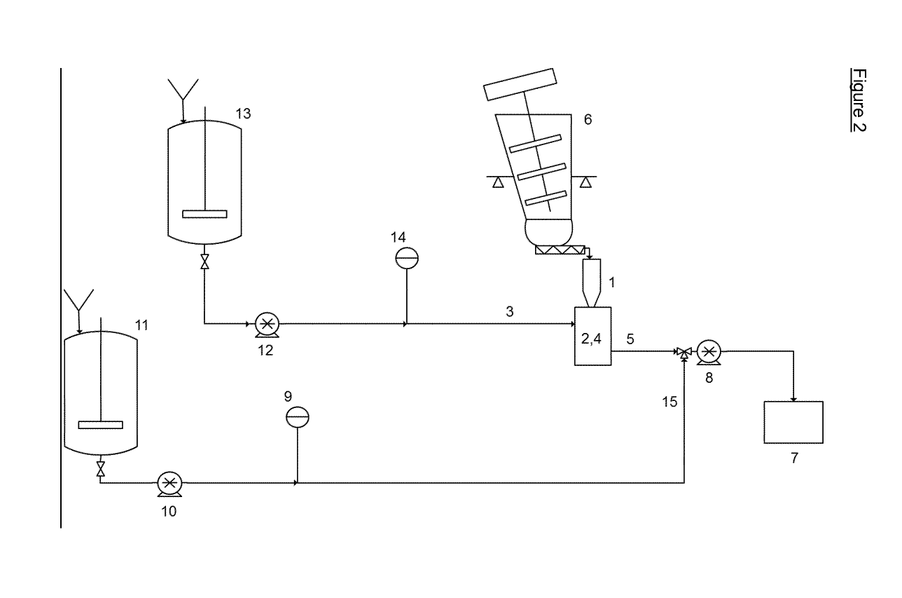

FIG. 2 illustrates another embodiment of the process. In addition to the components present in FIG. 1, this embodiment further comprises a second liquid tank (11) containing a second liquid. A liquid stream from the second liquid tank (11) is pumped via dosing pump (10) through the second liquid feed line (15). The liquid feed line further comprises a flow meter (9). The second liquid feed line (15) is connected with the dispersion outlet line (5), and the contents of the both are mixed in mixing pump (8). The resulting product is collected in a product container (7). The second liquid feed line allows to adjust the solids content of the dispersion leaving the mixing and dispersing chamber (2,4).

1. A continuous paint production process for dispersing a particulate solid material in a liquid comprising
a) dosing a particulate solid material feed stream via a particulate solid feed line into a mixing chamber,
b) simultaneously dosing a liquid feed stream via a liquid feed line into the mixing chamber, wherein at least one of the feed streams additionally comprises an organic film-forming binder,
c) simultaneously exerting a shear force on the content of the mixing chamber sufficient to mix the particulate solid material and the liquid to form a mixture of particulate solid in the liquid, and
d) simultaneously exerting a shear force to the mixture of particulate solid in the liquid sufficient to reduce the particle size of the particulate solid material in a dispersing chamber to form a particulate solid material dispersed in the liquid, and
e) simultaneously removing a liquid product stream of particulate solid material dispersed in the liquid from the dispersing chamber via a liquid dispersion outlet line,
wherein the mixing chamber and the dispersing chamber are one single chamber (2,4),
wherein the particulate solid material is in the form of powder, granules or pellets, wherein an at least second liquid feed stream is dosed to the liquid dispersion outlet line.

2. The process according to claim 1, wherein the mixing and dispersing are carried out in a rotor-stator device.

3. The process according to claim 1, wherein the liquid feed stream comprises an organic film-forming binder.

4. The process according to claim 1, wherein the particulate solid material feed stream comprises an organic film-forming binder.

5. The process according to claim 1, wherein the particulate solid material comprises a material selected from pigments, fillers, extenders, and mixtures thereof.

6. The process according to claim 1, wherein the particulate solid material is a mixture of at least two different materials.

7. The process according to claim 1, wherein the liquid is a mixture of at least two different materials.

8. The process according to claim 1, wherein in a) at least two different particulate solid materials are dosed via at least two particulate solid feed lines into the mixing chamber.

9. The process according to claim 1, wherein in b) at least two different liquid feed streams are dosed via at least two liquid feed lines into the mixing chamber.

10. The process according to claim 1, wherein in step d) an at least second liquid feed stream is dosed to the dispersing chamber via an at least second liquid feed line.

11. The process according to claim 1, wherein the liquid is an aqueous liquid.

12. The process according to claim 1, wherein the liquid is a non-aqueous liquid.

13. The process according to claim 1, wherein the liquid product stream is a paint or paint precursor.
